(19) United States
(12) Patent Application Publication
(10) Pub. No.: US 2013/0076854 A1
(43) Pub. Date: Mar. 28, 2013

(54) IMAGE PROCESSING APPARATUS, IMAGE PROCESSING METHOD, AND COMPUTER READABLE MEDIUM

(71) Applicant: Fujio IHARA, Kanagawa (JP)

(72) Inventor: Fujio IHARA, Kanagawa (JP)

(73) Assignee: FUJI XEROX CO., LTD., Tokyo (JP)

(21) Appl. No.: 13/398,410

(22) Filed: Feb. 16, 2012

(30) Foreign Application Priority Data
Sep. 22, 2011 (JP) 2011-206883

(51) Int. Cl. H04N 7/00; G06K 9/68

(52) U.S. Cl. 348/36; 382/218; 348/E05.024

(57) ABSTRACT

An image processing apparatus includes an image information acquiring unit, a quality determining unit, a positional information acquiring unit, and a panoramic image information generating unit. The image information acquiring unit acquires plural pieces of image information. The quality determining unit determines whether or not the quality of each of the plural pieces of image information meets predetermined criteria. The positional information acquiring unit acquires, on the basis of the plural pieces of image information, positional information indicating the positional relationship among the plural pieces of image information. The panoramic image information generating unit generates, on the basis of a determination result obtained by the quality determining unit, the positional information, and the plural pieces of image information, panoramic image information representing a panoramic image.

### CROSS-REFERENCE TO RELATED APPLICATIONS

This application is based on and claims priority under 35 USC 119 from Japanese Patent Application No. 2011-206883 filed Sep. 22, 2011.

### BACKGROUND

1. Technical Field

The present invention relates to an image processing apparatus, an image processing method, and a computer readable medium.

2. Summary

According to an aspect of the invention, there is provided an image processing apparatus including an image information acquiring unit, a quality determining unit, a positional information acquiring unit, and a panoramic image information generating unit. The image information acquiring unit acquires plural pieces of image information. The quality determining unit determines whether or not the quality of each of the plural pieces of image information meets predetermined criteria. The positional information acquiring unit acquires, on the basis of the plural pieces of image information, positional information indicating the positional relationship among the plural pieces of image information. The panoramic image information generating unit generates, on the basis of a determination result obtained by the quality determining unit, the positional information, and the plural pieces of image information, panoramic image information representing a panoramic image.

### BRIEF DESCRIPTION OF THE DRAWINGS

Exemplary embodiments of the present invention will be described in detail based on the following figures, wherein:

FIG. 1A is a plan view illustrating an example of an image processing apparatus according to an exemplary embodiment of the invention;

FIG. 1B is a side view illustrating the image processing apparatus according to the exemplary embodiment illustrated in FIG. 1A;

FIG. 2 is a diagram for explaining the configuration of an image processing apparatus according to an exemplary embodiment of the invention;

FIG. 3 is a diagram for explaining the functional configuration of an image processor illustrated in FIG. 2;

FIG. 4 is a diagram for illustrating the functional configuration of a quality determining unit illustrated in FIG. 3;

FIG. 5 is a diagram illustrating an example of a panoramic image according to an exemplary embodiment of the invention;

FIG. 6 is a diagram illustrating a display example of a frame image and tilt information according to an exemplary embodiment of the invention;

FIG. 7 is a flowchart illustrating an example of the flow of a process performed by an image processing apparatus according to an exemplary embodiment of the invention; and

FIG. 8 is a flowchart illustrating an example of the detailed flow of a process illustrated as step S102 of FIG. 7.

### DETAILED DESCRIPTION

Hereinafter, exemplary embodiments of the invention will be explained with reference to the drawings. In the drawings, the same or similar elements are referred to with the same reference numerals and the explanations of those same or similar elements will be omitted.

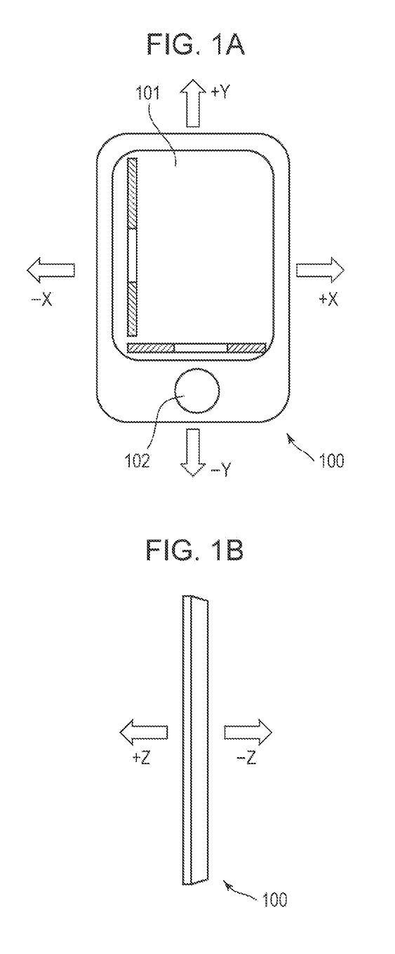

FIG. 1A is a plan view illustrating an example of an image processing apparatus according to an exemplary embodiment of the invention. FIG. 1B is a side view illustrating the image processing apparatus according to the exemplary embodiment illustrated in FIG. 1A. As illustrated in FIGS. 1A and 1B, an image processing apparatus 100 according to this exemplary embodiment is, for example, a portable terminal or the like, and includes a display unit 101, an operating unit 102, and an image information acquiring unit 103 (not illustrated) including a camera and the like. The external appearance of the image processing apparatus 100 illustrated in FIGS. 1A and 1B are merely an example, and the external appearance of the image processing apparatus 100 is not limited to this.

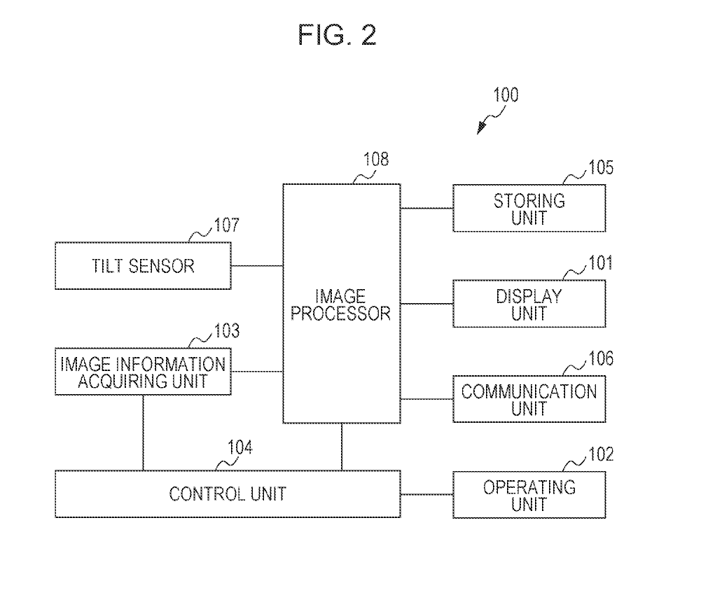

FIG. 2 is a diagram for explaining the configuration of an image processing apparatus according to an exemplary embodiment of the invention. As illustrated in FIG. 2, in terms of functions, the image processing apparatus 100 includes, for example, the display unit 101, the operating unit 102, the image information acquiring unit 103, a control unit 104, a storing unit 105, a communication unit 106, a tilt sensor 107, and an image processor 108. The configuration illustrated in FIG. 2 is merely an example, and the configuration of the image processing apparatus 100 is not limited to this.

The image information acquiring unit 103 includes, for example, a camera including an imaging element (not illustrated) such as a charge coupled device image sensor (CCD image sensor) and the like, and acquires image information (frame image) of an imaging object. The control unit 104 is, for example, a central processing unit (CPU), a microprocessing unit (MPU), or the like, and operates in accordance with a program stored in the storing unit 105.

The storing unit 105 includes, for example, an information recording medium such as a read-only memory (ROM), a random-access memory (RAM), a hard disk, or the like, and stores a program to be executed by the control unit 104. The storing unit 105 also operates as a work memory for the control unit 104. The program may be, for example, supplied by being downloaded via a network or supplied by various computer-readable information recording media such as a compact disc read-only memory (CD-ROM), a digital versatile disk read-only memory (DVD-ROM), and the like. The communication unit 106 allows connection between the image processing apparatus 100 and another image processing apparatus 100, a personal computer, and the like via a network.

The operating unit 102 includes, for example, a button, a touch panel, or the like, and outputs, in accordance with an instructing operation performed by a user, the contents of the instructing operation to the control unit 104. In the case where the operating unit 102 includes a touch panel, the operating unit 102 may be configured integrally with the display unit 101, which will be described later, or part of the operating unit 102 may be configured integrally with the display unit 101.

The display unit 101 is, for example, a liquid crystal display, an organic electroluminescence (EL) display, or the like, and displays information in accordance with an instruction from the control unit 104. The tilt sensor 107 is, for example, an acceleration sensor, and detects, for example, tilt of the camera provided in the image information acquiring unit 103 at predetermined intervals such as one-frame intervals.

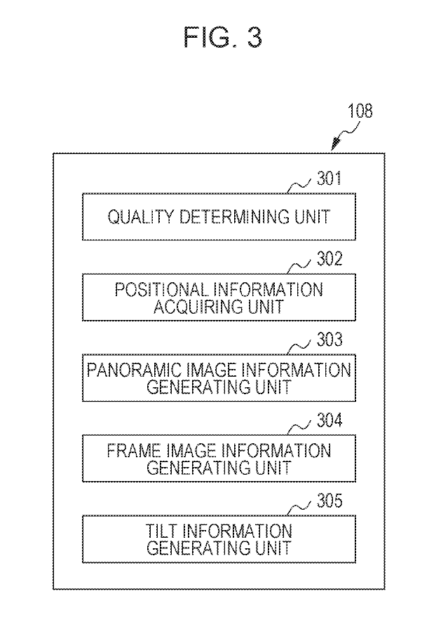

The image processor 108 performs image processing for image information acquired by the image information acquiring unit 103 in accordance with an instruction from the control unit 104. More specifically, as illustrated in FIG. 3, in terms of functions, the image processor 108 includes a quality determining unit 301, a positional information acquiring unit 302, a panoramic image information generating unit 303, a frame image information generating unit 304, and a tilt information generating unit 305.

The quality determining unit 301 determines whether or not individual pieces of image information acquired by the image information acquiring unit 103 meet predetermined criteria. If it is determined that image information meets the predetermined criteria, the image information is stored into the storing unit 105. Meanwhile, if it is determined that image information does not meet the predetermined criteria, the image information is not stored into the storing unit 105. More specifically, the quality determining unit 301 makes a determination as to whether or not image information meets criteria (desired image quality criteria) based on the size of a character and the like, such as, for example, a determination as to whether or not a character included in acquired image information is viewable, a determination as to whether or not optical character recognition of a character included in acquired image information can be done using an optical character reader (OCR), or the like. For example, the determination as to which criteria is to be used (for example, which one of the determination as to whether or not image information is viewable and the determination as to whether or not image information can be processed with OCR is to be made), the determination as to whether or not plural criteria are to be used (for example, the determination as to whether or not both the determination as to whether or not image information is viewable and the determination as to whether or not image information can be processed with OCR are to be made), or the like may be made in accordance with an instruction issued by a user using the operating unit 102.

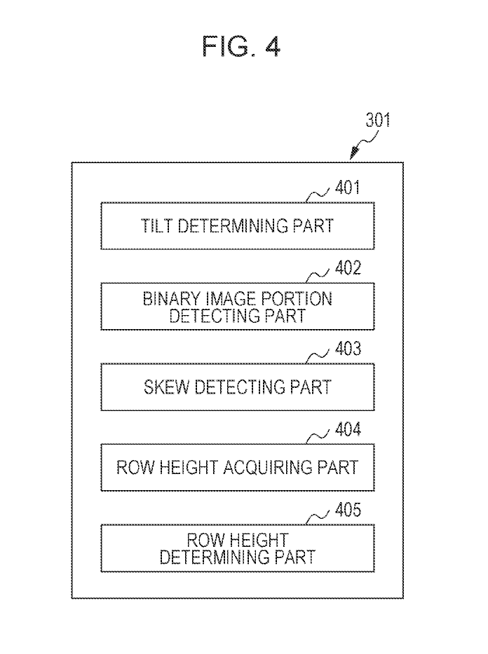

As illustrated in FIG. 4, more specifically, the quality determining unit 301 includes, for example, a tilt determining part 401, a binary image portion detecting part 402, a skew detecting part 403, a row height acquiring part 404, and a row height determining part 405.

The tilt determining part 401 determines whether tilt information acquired by the tilt sensor 107 falls within or outside a predetermined range (reference range). If it is determined that the tilt information acquired by the tilt sensor 107 falls outside the reference range, the tilt determining part 401 deletes image information corresponding to the tilt information. Meanwhile, if it is determined that the tilt information acquired by the tilt sensor 107 falls within the reference range, the tilt determining part 401 causes the binary image portion detecting part 402 to acquire image information corresponding to the individual determination results.

The binary image portion detecting part 402 detects binary image portions represented as binary images included in the individual pieces of image information for which it is determined that the tilt information acquired by the tilt sensor 107 falls within the predetermined range. In the case where the tilt sensor 107 is not employed, the binary image portion detecting part 402 is configured to detect binary image portions included in individual pieces of image information acquired by the image information acquiring unit 103.

The skew detecting part 403 detects a skew generated when each image is captured. More specifically, the skew detecting part 403 calculates the rotation angle in X and Y directions of the camera when each image is captured. The X and Y directions correspond to, for example, X and Y directions illustrated in FIGS. 1A and 1B. For example, in the case where the tilt sensor 107 is employed, the rotation angle may be detected on the basis of output from the tilt sensor 107. In the case where the tilt sensor 107 is not employed, the rotation angle may be detected by changing the angle of each image represented by an acquired corresponding piece of image information and calculating projection of the image.

The row height acquiring part 404 acquires, for example, projection along the direction of a detected rotation angle. In the case where the row of a character string represented in a binary image portion is recognized, the row height acquiring part 404 acquires the row height of the character string. The row height determining part 405 determines whether or not the acquired row height is equal to a reference height or more. The reference height is calculated in accordance with a character height determined on the basis of the desired image quality criteria. If the row height determining part 405 determines that the acquired row height is equal to the reference height or more, it is determined that the image information meets the desired image quality criteria, and the image information is stored into the storing unit 105. Meanwhile, if the row height determining part 405 determines that the acquired row height is less than the reference height, it is determined that the image information does not meet the desired image quality criteria, and the image information is not stored into the storing unit 105.

The positional information acquiring unit 302 calculates and acquires the position of image information that is determined to meet the desired image quality criteria by the quality determining unit 301 from among acquired image information. The positional information acquiring unit 302 may also be configured to calculate and acquire the enlargement and reduction ratio. The panoramic image information generating unit 303 generates panoramic image information representing a panoramic image from the image information determined to meet the desired image quality criteria by the quality determining unit 301, on the basis of the calculated positional information. Therefore, a portion corresponding to a part image for which image information is determined not to meet the desired image quality criteria of the generated panoramic image is represented as a blank portion.

More specifically, for example, the positional information acquiring unit 302 calculates so-called local feature amounts of individual images. The panoramic image information generating unit 303 calculates appropriate connection positions and enlargement and reduction ratio of the individual images by causing the images to be superimposed so as to minimize the difference among the local feature amounts, and generates panoramic image information representing a panoramic image. For example, a so-called scale-invariant feature transform (SIFT) technique may be used for detecting the local feature amounts. With this technique, by obtaining the closeness among 128-order feature amounts of feature points called key points acquired from plural images, the positions of corresponding key points in different frame images are obtained. Furthermore, on the basis of the relation among plural key points, the rotation angle and enlargement and reduction ratio are also obtained. An image for which the feature amounts are not detected is not used for generation of panoramic image information.

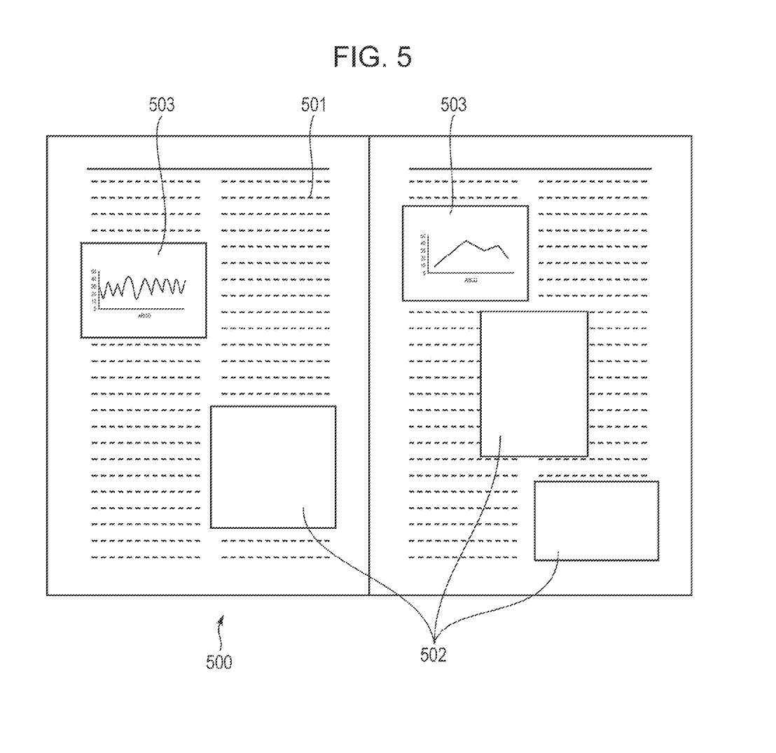

An example of a panoramic image represented by panoramic image information generated by the panoramic image information generating unit 303 will be explained with reference to FIG. 5. As illustrated in FIG. 5, a panoramic image 500 includes a panoramic image portion (including an image portion 503 representing an image and a character portion 501 representing characters in an imaging object) generated from image information determined to meet the desired image quality criteria by the quality determining unit 301 and a blank portion 502 corresponding to a part image for which image information is determined not to meet the desired image quality criteria. A user visually recognizes the portion for which image information does not to meet the desired image quality criteria, that is, the blank portion 502, on the basis of the position and the like of the blank portion 502 of the panoramic image 500. Thus, the user is urged to perform a re-photographing operation for the portion corresponding to the blank portion of the imaging object, and a complete panoramic image including the entire imaging object is acquired by the re-photographing operation. The character portion 501 corresponds to a portion detected by the binary image portion detecting part 402. The blank portion 502 may be represented in a different way, for example, may be displayed so as to include characters indicating a warning message or the like, as long as a portion for which image information does not meet the desired image quality criteria is identified.

The frame image information generating unit 304 generates frame image information indicating a frame corresponding to the minimum size of a character required for acquiring image information that meets specified desired image quality criteria. More specifically, for example, in the case where the minimum recognizable character size of an OCR engine to be used is represented by X point, the input resolution is represented by Ydpi and the resolution of the camera in a photographing mode used in the image information acquiring unit 103 is represented by Zdpi (Z>Y), the character height at the time of OCR input is required to be Y×X/72 pixels or more. Furthermore, when the resolution of the camera is Z, since Y/Z-fold resolution conversion is required before OCR input, a pixel size of Z/Y×Y×X/72 pixels=Z×X/72 pixels or more is required. Thus, frame image information may be configured to indicate a frame image of the above-mentioned size or more. That is, for example, in the case where the minimum recognizable character size of an OCR engine to be used is set to 6 point, the input resolution is set to 200 dpi, and the resolution of the camera in the photographing mode is set to 300 dpi, a character size (character height) of 25 pixels is required. Thus, a frame having the above-mentioned size or more may be displayed on the display unit 101. Furthermore, the tilt information generating unit 305 generates tilt information indicating the degree of tilt of the camera used in the image information acquiring unit 103 on the basis of information from the tilt sensor 107.

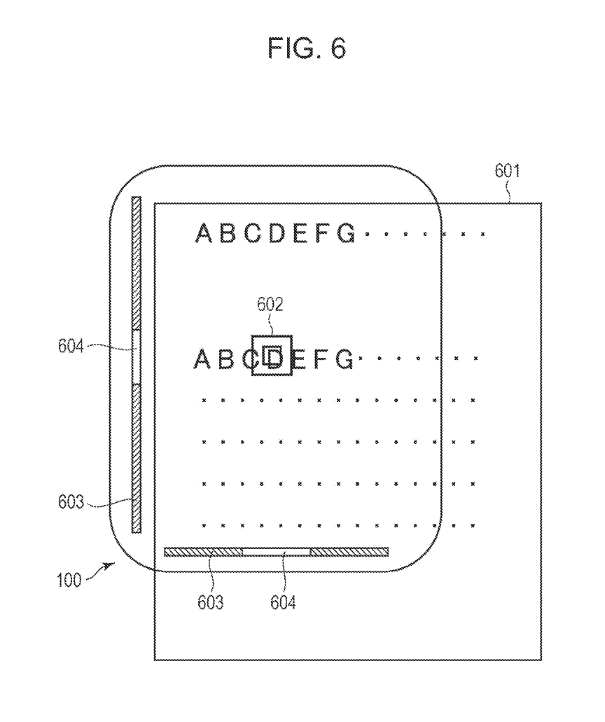

More specifically, for example, as illustrated in FIG. 6, when a user sequentially moves the image processing apparatus 100 according to this exemplary embodiment on a document 601 represented on a paper medium serving as an imaging object, an image of the entire document 601 is captured. In the meantime, part of the document 601 whose image is currently being captured is acquired by the image information acquiring unit 103 and displayed on the display unit 101. At this time, a frame image 602 represented by frame image information generated by the frame image information generating unit 304 is also displayed on the display unit 101. The frame image 602 is, for example, configured to be double frames, as illustrated in FIG. 6. For example, an inner frame corresponds to a viewable character size, and an outer frame corresponds to a character size that can be processed with OCR. The document 601 may contain an image portion represented as an image.

Accordingly, when a user performs a photographing operation for the document 601 on the basis of the frame image 602, acquisition of a panoramic image for which image information meets the desired image quality criteria can be ensured. More specifically, for example, in the case where a user desires to acquire a viewable panoramic image, the user performs a photographing operation while performing adjustment of the distance between the document 601 and the image processing apparatus 100 or the like in such a manner that the size of characters displayed on the display unit 101 falls outside the inner frame. For example, in the case where a user desires to acquire a panoramic image that can be processed with OCR, the user performs a photographing operation while performing adjustment of the distance between the document 601 and the image processing apparatus 100 or the like in such a manner that the size of characters displayed on the display unit 101 falls outside the outer frame. The case where double frames are displayed as the frame image 602 has been explained above with reference to FIG. 6. However, only one of the outer and inner frames of the frame image 602 may be displayed when a user specifies one of the desired image quality criteria (for example, whether or not an image is viewable or whether or not an image can be processed with OCR).

Furthermore, for example, as illustrated in FIG. 6, tilt information generated by the tilt information generating unit 305 is displayed on the display unit 101 so as to be superimposed on a captured image, and indicates tilt in the X and Y directions. More specifically, for example, tilt information displayed on the display unit 101 includes bar-like portions 603 in the X and Y directions and movement portions 604 that move in accordance with tilt in the individual directions, as illustrated in FIG. 6. The movement portions 604 move from the center of the bar-like portions 603 in accordance with tilt of the image processing apparatus 100. Thus, when a user performs a photographing operation to capture the entire image of the document 601 by moving the image processing apparatus 100 in such a manner that the movement portions 604 are located at the center of the bar-like portions 603, image information not affected by tilt can be acquired. In FIG. 6, for an easier explanation, the image processing apparatus 100 is illustrated in a transparent manner. In addition, the X and Y directions correspond to, for example, the corresponding directions illustrated in FIGS. 1A and 1B.

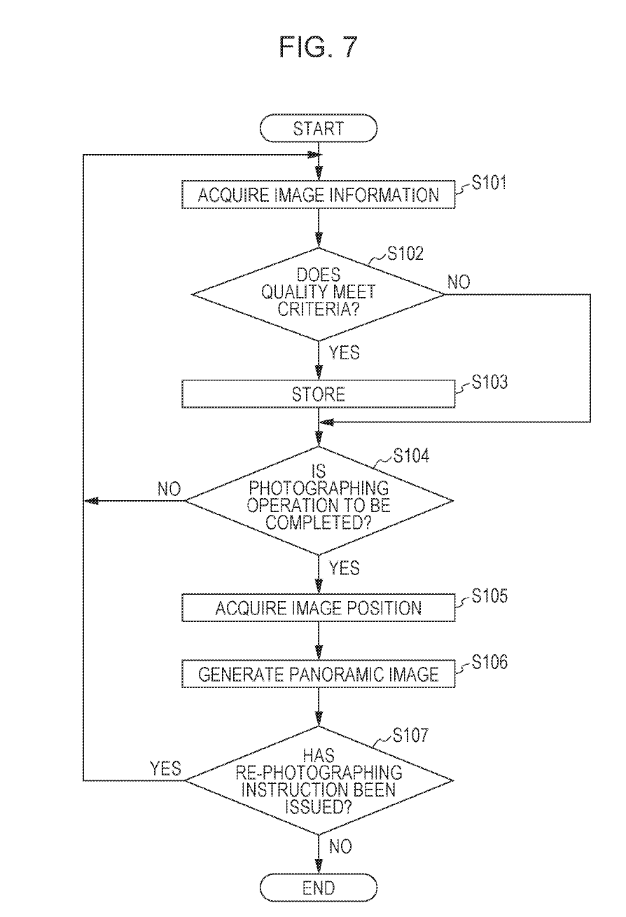

The overview of the flow of a process performed by an image processing apparatus according to an exemplary embodiment will now be explained with reference to FIG. 7. As illustrated in FIG. 7, for example, the image information acquiring unit 103 captures an image of an imaging object in accordance with a photographing start instruction from a user to the operating unit 102, and acquires image information of the object (step S101). The acquired image information is displayed on the display unit 101. Here, for example, a frame image and tilt information are displayed so as to be superimposed on an image displayed on the display unit 101.

The quality determining unit 301 determines whether or not individual pieces of image information meet desired image quality criteria (step S102). If it is determined that image information meets the desired image quality criteria, the image information is stored into the storing unit 105 (step S103). If it is determined that image information does not meet the desired image quality criteria, the image information is not stored into the storing unit 105. Accordingly, only image information determined to meet the desired image quality criteria is stored in the storing unit 105.

It is determined whether or not an instruction for terminating a photographing operation has been issued (step S104). If it is determined that an instruction for terminating a photographing operation has been issued, the image information acquiring unit 103 terminates acquisition of image information. Then, the process proceeds to step S105. If it is determined that an instruction for terminating a photographing operation has not been issued, the process returns to step S101. The photographing operation is terminated, for example, when the user issues an instruction for terminating a photographing operation via the operating unit 102.

The positional information acquiring unit 302 acquires positional information indicating positions of individual pieces of image information stored in the storing unit 105 in panoramic image information to be generated (step S105). The panoramic image information generating unit 303 generates panoramic image information on the basis of the image information determined to meet the desired image quality criteria and stored in the storing unit 105 and the positional information (step S106). The panoramic image information is, for example, displayed on the display unit 101 as a panoramic image. The panoramic image information is displayed, for example, when the user instructs the operating unit 102 to display a panoramic image.

Then, it is determined whether or not a portion (part image) for which image information is determined not to meet the desired image quality criteria exists and a re-photographing instruction has been issued (step S107). If it is determined that no corresponding part image exists, the process is terminated. If it is determined that a corresponding part image exists and a re-photographing instruction has been issued, the process returns to step S101. This determination may be made, for example, when the user visually recognizes the panoramic image. Alternatively, for example, when the image processing apparatus 100 determines that the panoramic image contains a blank portion having a certain size or more, it may be determined that the corresponding part image exists.

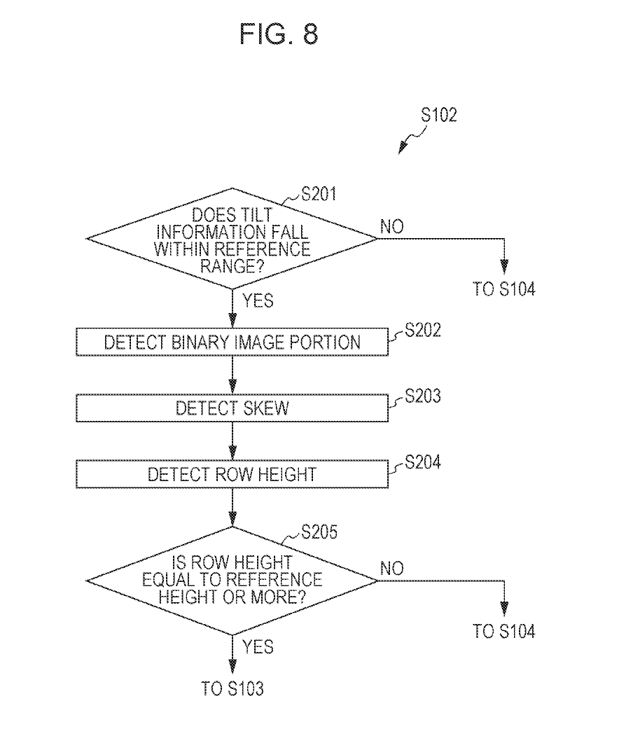

FIG. 8 illustrates an example of the details of the process of step S102 illustrated in FIG. 7. As illustrated in FIG. 8, the tilt determining part 401 determines whether or not tilt information acquired by the tilt sensor 107 falls within a predetermined range (reference range) (step S201). If it is determined that the tilt information acquired by the tilt sensor 107 falls outside the reference range, the process proceeds to step S104.

The binary image portion detecting part 402 detects a binary image portion represented as a binary image contained in each piece of image information for which it is determined that the tilt information acquired by the tilt sensor 107 falls within the predetermined range (step S202). The skew detecting part 403 detects a skew generated when the image is captured (step S203). For example, the row height acquiring part 404 acquires projection along the direction of a detected rotation angle, and when the row of a character string represented in the binary image portion is visually recognized, the row height acquiring part 404 acquires the row height (step S204).

The row height determining part 405 determines whether or not the acquired row height is equal to a reference height or more (step S205). If the row height determining part 405 determines that the acquired row height is equal to the reference height or more, the process proceeds to step S103, and the image information, which is determined to meet the desired image quality criteria, is stored into the storing unit 105. If the row height determining part 405 determines that the acquired row height is less than the reference height, the process proceeds to step S104.

The flows of the processes illustrated in FIGS. 7 and 8 are merely examples and may be replaced with substantially the same configurations as the above-described flows, configurations achieving the same operation effects as those of the above-described flows, or configurations achieving the same purposes as those of the above-described flows. For example, in the flows described above, in step S102, it is determined whether or not individual pieces of image information meet predetermined criteria, and image information determined to meet the predetermined criteria is stored into the storing unit 105 or the like. However, individual pieces of image information may be stored in advance in the storing unit 105 or the like, and image information determined not to meet the predetermined criteria may be deleted. Furthermore, instead of the flow of determining the quality of individual pieces of image information illustrated in FIG. 8, it may be determined, by causing an optical character recognizing unit (not illustrated) provided in the image processing apparatus 100 to actually perform OCR, whether or not the quality of individual images meets desired image quality criteria (in the case where an instruction to make a determination as to whether or not an image can be processed with OCR has been issued).

The present invention is not limited to the foregoing exemplary embodiments and may be replaced with substantially the same configuration, a configuration achieving the same operation effects, or a configuration achieving the same purpose as the configuration illustrated in any of the exemplary embodiments. More specifically, for example, the case where tilt information is displayed on the display unit 101 has been explained in the foregoing exemplary embodiments. However, the tilt information might not be displayed. In addition, the image processing apparatus 100 might not include the tilt sensor 107. Furthermore, the case where the image processing apparatus 100 corresponds to the portable terminal illustrated in FIG. 1 has been explained in the foregoing exemplary embodiments. However, the image processing apparatus 100 might not be such a portable terminal. For example, the quality determining unit 301, the positional information acquiring unit 302, the panoramic image information generating unit 303, and the like may be implemented by computers or the like connected via a network. That is, the image information acquiring unit 103 including a camera and the like and the other units may be configured in a separated manner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image information acquiring unit that acquires a plurality of pieces of image information;
a quality determining unit that determines whether or not the quality of each of the plurality of pieces of image information meets predetermined criteria;
a positional information acquiring unit that acquires, on the basis of the plurality of pieces of image information, positional information indicating the positional relationship among the plurality of pieces of image information; and
a panoramic image information generating unit that generates, on the basis of a determination result obtained by the quality determining unit, the positional information, and the plurality of pieces of image information, panoramic image information representing a panoramic image.

2. The image processing apparatus according to claim 1, wherein the panoramic image information generating unit generates the panoramic image information on the basis of, among the plurality of pieces of image information, a plurality of pieces of image information other than image information that is determined not to meet the predetermined criteria by the quality determining unit.

3. The image processing apparatus according to claim 1, further comprising:
a display unit that displays each of the plurality of pieces of image information; and
a frame image information generating unit that generates frame image information indicating a frame image conforming to the predetermined criteria,
wherein the display unit displays the frame image so as to be superimposed on an image represented by the displayed image information.

4. The image processing apparatus according to claim 2, further comprising:
a display unit that displays each of the plurality of pieces of image information; and
a frame image information generating unit that generates frame image information indicating a frame image conforming to the predetermined criteria,
wherein the display unit displays the frame image so as to be superimposed on an image represented by the displayed image information.

5. The image processing apparatus according to claim 3, further comprising:
a tilt detecting unit that detects tilt of the image processing apparatus; and
a tilt information generating unit that generates tilt information corresponding to the tilt detected by the tilt detecting unit,
wherein the display unit displays the frame image and the tilt information so as to be superimposed on the image represented by the image information.

6. The image processing apparatus according to claim 4, further comprising:
a tilt detecting unit that detects tilt of the image processing apparatus; and
a tilt information generating unit that generates tilt information corresponding to the tilt detected by the tilt detecting unit,
wherein the display unit displays the frame image and the tilt information so as to be superimposed on the image represented by the image information.

7. The image processing apparatus according to claim 1, wherein the quality determining unit determines whether or not the size of a character represented by character information included in the image information is equal to a predetermined size or more.

8. The image processing apparatus according to claim 2, wherein the quality determining unit determines whether or not the size of a character represented by character information included in the image information is equal to a predetermined size or more.

9. The image processing apparatus according to claim 3, wherein the quality determining unit determines whether or not the size of a character represented by character information included in the image information is equal to a predetermined size or more.

10. The image processing apparatus according to claim 4, wherein the quality determining unit determines whether or not the size of a character represented by character information included in the image information is equal to a predetermined size or more.

11. The image processing apparatus according to claim 5, wherein the quality determining unit determines whether or not the size of a character represented by character information included in the image information is equal to a predetermined size or more.

12. The image processing apparatus according to claim 6, wherein the quality determining unit determines whether or not the size of a character represented by character information included in the image information is equal to a predetermined size or more.

13. The image processing apparatus according to claim 7, wherein the predetermined size is determined on the basis of a size that can be processed with optical character recognition.

14. The image processing apparatus according to claim 8, wherein the predetermined size is determined on the basis of a size that can be processed with optical character recognition.

15. The image processing apparatus according to claim 9, wherein the predetermined size is determined on the basis of a size that can be processed with optical character recognition.

16. The image processing apparatus according to claim 10, wherein the predetermined size is determined on the basis of a size that can be processed with optical character recognition.

17. The image processing apparatus according to claim 11, wherein the predetermined size is determined on the basis of a size that can be processed with optical character recognition.

18. The image processing apparatus according to claim 12, wherein the predetermined size is determined on the basis of a size that can be processed with optical character recognition.

19. An image processing method comprising:
acquiring a plurality of pieces of image information;
determining whether or not the quality of each of the plurality of pieces of image information meets predetermined criteria;
acquiring, on the basis of the plurality of pieces of image information, positional information indicating the positional relationship among the plurality of pieces of image information; and
generating, on the basis of an obtained determination result, the positional information, and the plurality of pieces of image information, panoramic image information representing a panoramic image.

20. A computer readable medium storing a program causing a computer to execute a process for performing image processing, the process comprising:
acquiring a plurality of pieces of image information;
determining whether or not the quality of each of the plurality of pieces of image information meets predetermined criteria;
acquiring, on the basis of the plurality of pieces of image information, positional information indicating the positional relationship among the plurality of pieces of image information; and
generating, on the basis of an obtained determination result, the positional information, and the plurality of pieces of image information, panoramic image information representing a panoramic image.
